(19) United States
(12) Patent Application Publication
(10) Pub. No.: US 2023/0228538 A1
(43) Pub. Date: Jul. 20, 2023

(54) EFFICIENT TRANSMISSION OF MATTER AND ENERGY VIA QUANTUM PHASE MODULATION

(71) Applicant: Will Ragan, Bluffton, SC (US)

(72) Inventor: Will Ragan, Bluffton, SC (US)

(21) Appl. No.: 17/873,317

(22) Filed: Jul. 26, 2022

Related U.S. Application Data
(63) Continuation of application No. 17/584,191, filed on Jan. 25, 2022.
Application No. 17/584,191 is a continuation of application No. 63/147,599, filed on Feb. 9, 2021.

(51) Int. Cl. F41H 13/00; G21K 5/04

(52) U.S. Cl. CPC F41H 13/0043; G21K 5/04

(57) ABSTRACT

Matter and energy are delivered by superimposing multiple quantum wave states such that composite wave amplitudes are maximized at delivery target points and/or minimized at designated intermediate points. One or more target locations are identified for delivery of matter or energy waves, analyzing the medium along the transit path from the emitters, calculating interaction probabilities at each point along the medium, creating a scoring system for optimizing and limiting thresholds of interaction in designated regions; and calculating a combination of wave frequencies, emitter locations and vectors such that quantum interference between the beams optimizes the scoring outcome. The scoring system may be used to reward amplitudes within a specified range over a specified volume of space and penalized if the amplitude falls outside the range. The combined beam may be used for various purposes, including without limitation biological or military target compromise or elimination, electrical energy delivery, etc.

### REFERENCE TO RELATED APPLICATIONS

This application is a continuation of U.S. Utility patent application Ser. No. 17/584,191, filed Jan. 25, 2022, and also claims priority to, and the benefit of, U.S. Provisional Patent Application Ser. No. 63/147,599, filed Feb. 9, 2021, the entire content of both Related applications being incorporated herein by reference.

### FIELD OF INVENTION

The invention relates to transmission and delivery of matter and energy by superimposing multiple quantum wave states such that composite wave amplitudes are maximized at delivery target points and minimized at designated intermediate points.

### BACKGROUND OF THE INVENTION

The advent of quantum physics in the early twentieth century changed the way we view physical reality. It has made possible semiconductors, nuclear power, and quantum computing. Quantum physics is notoriously difficult to grasp, yet predictions are borne out flawlessly in experiments. The famous physicist Richard Feynman said, “I think I can safely say that no one understands quantum physics.”

One of the paradigm-shifts that quantum physics brought is the idea that objects are not always in a specific place at a specific time. All matter and energy are ultimately governed by the Schrodinger equation which describes how an unobserved particle spreads out via a quantum probability field calculated by the equation. When the measurement of a particle is observed, some of its attributes (possibly position) may take on definite values with certainty. Based on the Schrodinger equation, a particle may be likely to be found at certain places, while unlikely in others. What causes or constitutes observation, and the ensuing collapse of the probability field (wave function collapse) to specific parameters, is the source of much debate and experimentation.

In 1954 Max Born was awarded the Nobel Prize in Physics for showing how the Schrodinger equation describing quantum wave functions could be interpreted statistically. Of specific interest, he proved the probability of finding a particle at a specific place is related to the square of the amplitude of the Schrodinger equation calculated at that point in spacetime. If the amplitude of a wave function is zero at a point, the square of the amplitude is zero, and there is no possibility of finding the particle there.

Interestingly, amplitudes for quantum wave functions not only add but subtract where they overlap in space. The presence of a quantum particle can be negated by transmitting another identical quantum particle that is out of phase such that it has a negative amplitude that offsets the positive amplitude of the first particle.

The concept of wave cancellation and resonance is certainly familiar in the everyday world. Water waves can create interference patterns. Noise cancelling headphones cancel specific sound waves by sending out inverse waves. Troops marching across a bridge know not to move in lock step lest the resonance damage the structure. Electrical systems, such as three phase power, use wave interaction to maintain a minimum energy transfer during the power cycle.

It should be noted that there are limitations to wave interference and resonance in a classical compression wave (such as sound). The limits are determined by the properties of the medium. When moving back to the quantum world, those limitations disappear as the wave function can overlay the vacuum of space.

Quantum particles are generally divided into two categories, bosons and fermions. Bosons can be thought of as carriers of energy, such as photons and gravitons. Fermions are matter-like, such as protons and electrons. There is no theoretical limit to the density of bosons, while there is a limit to the number of fermions within an area of space. This is important because it means an unlimited number of differing bosonic quantum wave functions can be overlayed.

The presence of a quantum particle such as a photon, at a particular point does not guarantee its interaction with other objects. For example, the probability of photon absorption by an atom, relies on complex quantum physics. The probability of absorption of light traveling through a crystal is closely related to the photon wavelength and the lattice spacing of the crystal. So, the effective probability of quantum particles interacting with their surroundings is derived from composite wave function amplitude as well as the properties of the medium.

The vector orientation of a wave function is also of interest. Electromagnetic (EM) radiation consists of perpendicular waves of electric and magnetic quantum waves traveling through space in the same direction. EM waves can be polarized (aligned) in one direction or can also be circular—which means that the orientation of the electric and magnetic fields rotates through space. When quantum waves (such as light) interfere, the vector orientation must also be considered. This property is illustrated by the interference pattern created by a diffraction grating.

Efficiently delivering matter or energy to a specific point is critically important in many fields such as communications, manufacturing, weaponry, electrical transmission, and medicine. Preventing loss in transmission may be important for maximizing delivery as well as minimizing absorption in transit. Radiation treatments for cancer are an excellent example. Cancer is often treated by firing EM waves or protons at a target tumor. Unfortunately, the radiation must often cross through healthy tissue before reaching the tumor. To minimize the amount of radiation absorbed by healthy tissue, an array of emitters (sometimes as many 192) is positioned to fire at the target from many different angles. The rays converge at the target bringing a high radiation density to the tumor, and a more manageable density to surrounding tissue.

In many applications, including the above scenario, the efficiency of radiation delivery could be greatly improved using quantum wave interference.

### BRIEF SUMMARY OF THE INVENTION

This invention broadly discloses and claims systems, devices and methods for identifying one or more target locations for delivery of matter or energy waves, analyzing the medium along the transit path from the emitters, calculating interaction probabilities at each point along the medium, creating a scoring system for optimizing and limiting thresholds of interaction in designated regions; and calculating a combination of wave frequencies, emitter locations and vectors such that quantum interference between the beams optimizes the scoring outcome.

A system for delivering energy to a target comprises a plurality of emitters, each emitter outputting a beam of quantum waves with an amplitude and a frequency. The frequencies of at least some of the beams are different, such that the quantum waves intersect and interfere at different points with a composite wave amplitude. A quantum computer or other processor/controller executes a stored program to optimize the composite wave amplitude at a designated target.

One or more beam combiners may be used form at least one combined linear wave path directed to a designated target. Alternatively, a linear path may be formed without beam combiners (using free-electron lasers, for example), or hybrid beam generators may be used with and without beam combiners. The quantum waves may be polarized.

Amplitude cancellation may be used to minimize the presence and/or absorption of energy prior to, and after, a designated target. The various quantum waves have energy intensities, and the energy densities may be the same or different at the different frequencies. The system and method may include emitters with beams that are staggered or synchronized.

The computer processor may be operative to calculate a Targeting Solution using the following steps:

a) defining a Target Space Array based on physical coordinates of a region of space affected by the emitted energy, including a time frame associated with when the energy will be within the region, and wherein the Target Space Array is quantized to represent discrete points in time and space or defined as a set of continuous functions;

b) adding information to the Target Space Array describing absorption properties of each region based on the density of differing molecules relative to different energies and frequencies;

c) monitoring thermal properties of each region, and adjusting temperature if required as a function of energy absorption;

d) defining a scoring system that rewards or penalizes energy absorption in each region as a function of frequency and heat;

e) defining a formula for combining the scores of each region to determine a Suitability Score;

f) defining an Emitter Configuration Array including, for each emitter:
energy type, frequency and intensity,
potential location and vector orientation,
potential polarization, and
the ability to start or stop emission during the time frame defined in the target space array.

g) generating wave functions associated with every possible permutation in the Emitter Configuration Array;

h) combining the wave functions with the Target Space Array to assign a Suitability Score to a plurality of Targeting Solutions, wherein the Suitability Score is based on quantum interference of intersecting waves or classical approximations, taking into account reduction of wave intensity due to prior absorption or scattering along a path; and

i) defining an optimal Targeting Solution as a permutation of options in the Emitter Configuration Array that produces the highest Suitability Score for a specific Target Space Array.

A method of delivering energy to one or more targets, comprising the steps of:

generating a beam of energy comprising a plurality of interfering quantum waves;

wherein the quantum waves have amplitudes and frequencies;

wherein at least some of the frequencies are different, such that the waves form one or more composite amplitudes; and

optimizing the composite amplitude at one or more designated targets.

The waves may be polarized, and the beam of energy may be delivered along a single linear path. Amplitude cancellation may be used to minimize the presence and absorption of energy prior to, and after, a designated target, and the waves may have energy intensities that are the same or different at different frequencies. The emission points may be staggered, and/or the waves may be sychronized to enhance the optimization. The optimization may cause one or more ions or magnetic objects at a target to be moved, trapped, levitated, vibrated, heated, or cooled.

The scoring system according to the invention may be used to reward amplitudes within a specified range over a specified volume of space and penalized if the amplitude falls outside the range. This scoring could involve complex formulas and multiple ranges or be simplistic in nature. The amplitude and space ranges could have finite boundaries or be continuous. The absorption characteristics of the medium at all transit points would ideally be factored into the calculations. Absorption will reduce the quantum waves (of matter or energy) reaching points farther down the transit path. It will also determine temperature increases which could be critical in some applications. The heat dissipation properties may need to be factored in if there are relevant maximum limits, or if absorption will be affected (due to a change in the spacing of atomic nuclei). In some applications scattering or frequency shifts might also need to be considered.

Scoring may also incorporate combinatorial properties. For example, a high score might be given to a targeting solution that provides at least a minimum radiation level to each of a set of volume spaces. Additionally, scoring may be presented as a probability space because of uncertainty regarding the exact positions or characteristics of objects in the path of a particle or energy beam. Alternate scoring systems may be desired to provide a range of options. For example, in the context of the cancer radiation application, suppose that multiple types of healthy tissue must be crossed over to reach a tumor. Providing a different weighting to the penalty for affecting each tissue type would permit more subjective choices to be made when multiple solutions are calculated to optimize each score weighting. If no combination of radiation wave functions will permit a patient to retain both hearing and sight, then perhaps the best choices to keep one or the other can be presented.

A method of delivering energy or matter to one or more targets in accordance with the invention includes the step of generating a beam of radiation comprising a plurality of interfering quantum waves, wherein the quantum waves have amplitudes and frequencies, and wherein at least some of the frequencies are different, such that the amplitudes of the waves are maximized at one or more designated targets. In some embodiments the waves are polarized.

The amplitudes of the waves may also be minimized at one or more designated intermediate points, to penetrate or tunnel through barriers, for example.

In preferred embodiments, the beam of radiation is delivered along a single linear path with or without the use of beam combiners.

Amplitude cancellation may be used to maximize the resonant amplitude at the target(s), and/or minimize the presence or absorption of radiation prior to, or after, the target(s). The energy intensities of the waves may be the same or different at the different frequencies, and the method may further include the step of staggering the emission points of the waves to enhance effectiveness. The method may additionally include the step of favoring amplitudes within a specified range over a specified volume of space, or penalizing amplitudes that fall outside a given range. A high score may be assigned to a targeting solution that provides at least a minimum radiation level to each target.

The beam may be used for various purposes, including target elimination or compromise; to treat biological tissue; to deliver electrical energy; to heat a target; or as part of a weapon system.

### BRIEF DESCRIPTION OF THE DRAWINGS

FIG. 1 is a diagram illustrating a plurality of quantum waves at different frequencies, a target and multiple barriers;

FIG. 2 shows multiple emitters merged into a common bean through the use of one or more beam combiners;

FIG. 3 shows emitters on either side of a target with barriers on both sides; and

FIG. 4 depicts a series of aligned emitters directed toward a target without the use of a beam combiner.

### DETAILED DESCRIPTION OF THE INVENTION

In accordance with this invention, the efficiency of radiation delivery is greatly improved through the use of quantum wave interference. By sending polarized waves along a single linear path with different frequencies, amplitude cancellation can effectively minimize the presence and absorption of radiation prior to (and after) the target, while maximizing the resonant amplitude at the target(s). Additionally, the invention is applicable to multiple targets, and multiple areas where absorption should be minimized. The intensity of different frequencies might be different, and the emission points could also be staggered to create an optimal solution.

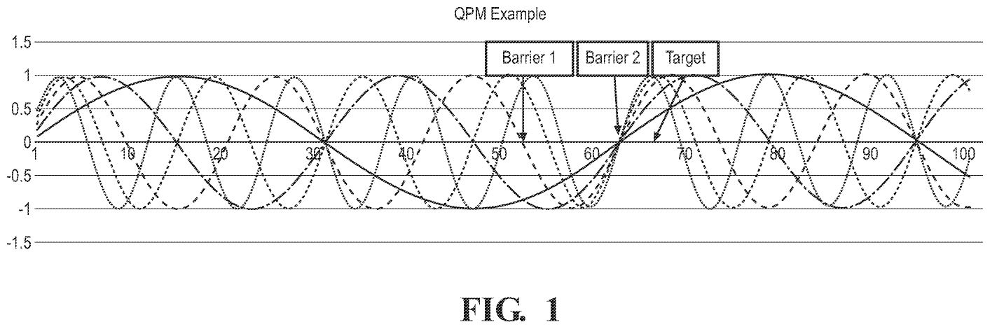

FIG. 1 is a diagram illustrating four quantum waves at different frequencies, a target and multiple barriers. The units along the X axis are arbitrary, starting at zero and continuing to 100. The Y axis shows amplitude, also arbitrary, from zero to positive one above the X axis, and zero to negative one below. While the waves are shown having similar amplitudes this is not necessary to the invention, nor is the number of waves shown. The waves may also be of the same or different “types” depending upon the frequency regime and type of particle mediating the energy transmission. Note that at Barrier 1, energy is minimized by the fact that there are waves with positive and negative amplitudes that act to cancel each other out. At Barrier 2, energy is minimized by the fact that the various waveforms are all essentially zero-crossing at or around a point. While not called out, energy is also minimized between 31 and 32 along the X axis.

To better understand the invention, reference is made to the following simplified scenario, with the understanding that the reference to “tumor” should be interpreted to mean any type of target of interest. A tumor (located 8 cm from an emitter array) is to be targeted with linear polarized photonic radiation along a single path. The tumor is encased by nerve fibers (at 7 cm and 9 cm) and healthy tissue on either side at 3 and 13 cm. We will ignore scattering and absorption properties, as well as heat, and score solely on the composite wave amplitudes delivered to each area. We will ignore the reduction in intensity due to absorption in transit. We will ignore the two- and three-dimensional aspects of the problem, showing the power of the technique on a simple one-dimensional problem. We will assume radiation is absorbed by each point based on 1/50 of the square of the wave amplitude of non-absorbed radiation (in reality this would be an integral over an area). By solving for linear polarized light rather than circular, we avoid the complexities of vector computation due to field rotation. Additionally, we will reduce the complex Schrodinger wave function and quantum interference calculations to the classical approximation of the familiar sine wave propagating through space. We will assume there are exactly four beams of equal intensity positioned 3 cm away from the first tissue layer. Assume the four beams can each be set to any wavelengths up to 20 cm (increments of 0.01 cm). The scoring system will be based on the absorption at the center of the tumor, and each of the nerves and healthy tissue areas. A reward weighting of 5 will be given to amplitude at the tumor, and a penalty weighting of −10 at the healthy tissue points and −20 at the nerve points.

An optimized solution (in cm) using (using GRG NonLinear calculation) is as follows:

| Emitter | Offset | Wavelength |
|---|---|---|
| 1 | 0.27 | 0.35 |
| 2 | 0 | 0.45 |
| 3 | 1.83 | 0.67 |
| 4 | 0 | 0.82 |

The score for this solution is 1.596. By contrast, a worst-case scenario yields a score of −7.41, harming the patient far more than helping. Even given the limited number of beams and oversimplified assumptions, the degrees of freedom created a potential solution space with 2.56×10\hat{ }26 possible answers.

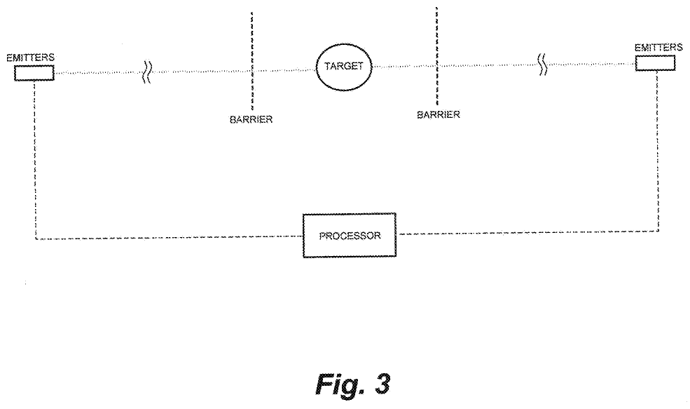

Note that by placing another set of quantum emitters at lower intensity on the other side of the target region at a 180-degree angle, we can dramatically increase the outcome. FIG. 3 shows one example of such an arrangement. The emitters can send out a quantum wave pattern that nullifies the radiation that travels unabsorbed past the tumor to the healthy tissue. This wave will then be partially absorbed at the tumor. Yet another set of emitters can then be setup on the first side with lower intensity to cancel out the 2nd set of radiation that travels past the tumor, and so on. An extremely high ratio of absorption in the tumor, relative to the surrounding tissue, can be achieved. There is a vast difference in the impact of different wave combinations as seen through the lens of the scoring system.

In a real-world situation, whether it be a targeting solution for a tumor or a ballistic nuclear missile, calculations would be more complicated due to factors such as absorption properties. The scoring would likely be more complex and the solution space vastly more so. In many cases there would be a nearly infinite number of frequency choices and emitter positions. For purposes of the limits of computation, some quantization would be necessary so that all permutations could be scored using Monte Carlo simulation (brute force). Reducing the “graininess” of the options would in turn enhance the outcomes. The problem could be solved in the framework of a high dimensional Hilbert Space with degrees of freedom related to each of the choices available. Mathematical tools exist to analyze such a system and eliminate blocks of variables as sub-optimal. In some simple cases, it may be possible to use multi-variate calculus to identify the exact point of global maxima.

Current technology provides for vast degrees of freedom in the number of wave beams that can be combined, and their properties. If brute force computation is required for all or part of a problem, it is easy to see that classical computers will be insufficient. The recent advent of commercially viable quantum computation makes the described technique highly efficient and feasible. In particular, the D Wave Systems adiabatic annealing quantum computer is ideally suited for solving this type of problem.

For simplicity, we will call the described technique Quantum Phase Modulation or QPM. Embodiments of QPM include the polarized or unpolarized emission of both matter and energy waves (generally fermions or bosons). They include waves traveling through space or through a medium (such as electricity). Other embodiments include a single set of emitters of identical vector as well as multiple emitters sets either on opposing vectors or at varying angles. In addition to combinations of frequencies and phase offsets, emitters might also combine multiple quantum wave types such as proton and electron beams, or magnetic and electric fields.

### Construction of a QPM Device

Once a QPM targeting solution has been designed, several factors are critical in the physical implementation. A complex scenario might involve many emitters surrounding an object and firing at many different angles and frequencies. In this case, positioning the emitters would be relatively easy—but might negate some of the benefits of quantum wave interference along a linear path. To construct a linear QPM device, the beams are not only parallel but should have precisely the same path. Lasers are often amplified by using waveguides to curve beam paths into a parallel stream. This would be inadequate, as beams separated by a wavelength or more will not produce interference.

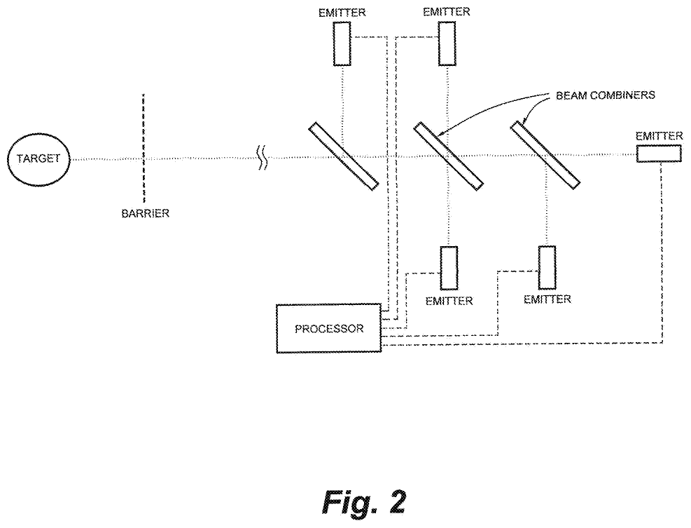

This issue is readily overcome by using a beam combiner. Beam combiners, such as those sold by Edmunds Optics, are readily available—utilizing a variety of techniques including dichroic mirrors and filled aperture combination. Beam combination is economical in the visible light spectrum and generally unnecessary in the radio spectrum (as sequential emitters may be able to broadcast through each other). FIG. 2 illustrates the use of a beam combiner merging multiple emitters 1, 2, . . . N. Those of skill in the art of optics and electromagnetic radiation will appreciate that multiple beam combiners may be used in some instances; that is, a first combiner merging two or more beams into a first combined beam, with additional combiners being used to further merge two or more single or merge beams into a common beam, and so on.

Controlling the frequency of emission is also important. Although photonic energy is quantized for a given frequency, there is no quantization of frequency itself in quantum physics. Any granular frequency can be achieved given the right apparatus. In practice, radio waves of any frequency can be readily produced by simply changing the electrical frequency input into an antenna. Emission of higher energy spectrum such as visible light is often tied to the properties of specific molecules or atoms being excited—thus many lasers emit at a specific frequency which cannot be directly altered.

If only a constrained set of specific frequencies is available, then a QPM calculation would be reduced in its degrees of freedom. An ideal QPM solution space would provide complete granularity in frequency within a given spectrum. Non-linear optics opens the door to the adjustment of frequency. Some crystals can increase photonic frequency by combining the energy of two photons into one, or vice versa.

In 1971, Stanford University built the first Free Electron Laser (FEL). This technology exploits both quantum physics and relativity to produce photon radiation at any frequency. In an FEL, electrons are fired past a series of magnets with alternating poles called an undulator. The undulator vibrates the electrons which in turn emit photons whose frequency is perfectly controlled by the magnetic vibration. This technology has seen significant gains in the last 20 years and has been used successfully as a surgical tool and a military weapon. FELs become very bulky when designed for the high energy spectrum, as the electrons must be accelerated to relativistic speeds—so this provides a practical limitation currently. However, FELs have been built to produce calibrated radiation all the way into the X-Ray spectrum.

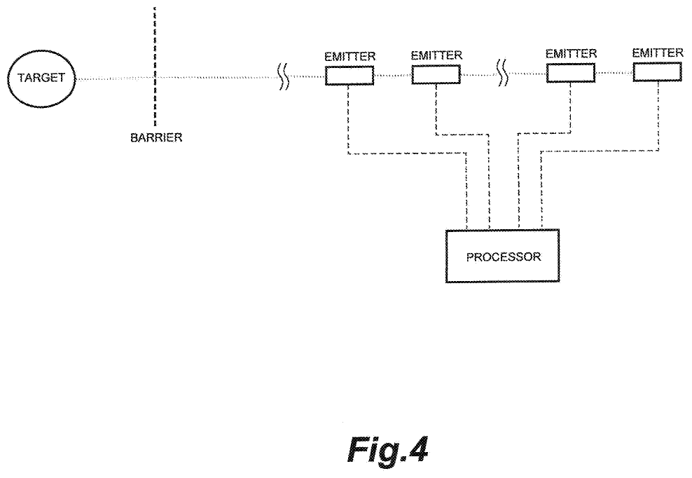

In some cases, FELs sidestep the need for a beam combiner—as different magnets along the undulator path can be adjusted to different frequencies, in turn producing different photon frequencies along the same linear path. FIG. 4 illustrates one example of a linear array of emitters without a beam combiner. FELs also can provide for phase shifts by simply altering the magnet positions creating undulations at specific frequencies. For example, a 1 mm gap might be placed between to two sets of magnets operating at different frequencies, to create a phase shift. Note that the invention does not preclude hybrid configurations wherein beam combiners are used for a subset of the emitted beams.

Photonic QPM devices can be constructed with current hardware operating all the way from the radio spectrum into the X-Ray spectrum. As a matter of economic practicality, QPM devices used for communication would likely be constructed using the radio spectrum, and the microwave and visible light spectrums for energy transfer purposes.

A basic multi-purpose device using current technology might consist of an FEL divided into magnet segments (perhaps 100) to produce different frequencies. Section gaps would be adjustable to allow phase shifts. All emission would pass through a polarization slit to maximize quantum interference. A 100 segment QPM device of this type would have 200 total degrees of freedom. Suppose that granular adjustments permit 1000 phase shift and 1 billion frequency settings per segment. The total permutations in the solution space would then be 10\hat{ }1200. After the scoring scenario is loaded into a supercomputer or quantum computer, the FEL would be set to the optimal configuration and ready to use.

As described earlier, QPM applies not only to bosons, but also to fermions such as electrons or protons. Electrically charged fermions are easy to manipulate using magnetic and electric fields. Electron gun technology has been around since the WWII era, and can be procured commercially from many companies including Kimball Physics. Producing, frequency tuning, and combining beams of charged particles can be achieved easily with current technology—making QPM possible right now for applications in electrical energy or for electron or proton radiation.

### Alternative Implementations

The preferred embodiment of QPM involves linear polarized waves combined along a straight path, so that quantum wave interference is easily controlled. Some applications could also involve waves being emitted in all directions or a range of directions from an aperture. Three-dimensional vector calculations would need to be performed in these scenarios. In some cases, the velocities of a particle (such as a proton) would change the corresponding Schrodinger equation and add additional computational factors. The propagation of bosons (such as photons) will be at the speed of light in a vacuum, but if traveling through a medium—the speed could change with frequency and QPM calculations must account for this.

Another embodiment of QPM would involve quantum wave superpositions. For example, a photon confronted with multiple probabilistic path options will take all paths in proportion to the probability of being found entirely on that path. These superpositions can in fact interfere or resonate the same as a fully separate wave function. Observation of paths can fully or partially collapse the fragmented wave function. Lab experiments have confirmed quantum wave interference of a single particle of matter or energy with itself. Using QPM on quantum waves in superposition may have uses in the construction of quantum computers, for example designing a circuit to use the Quantum Fourier Transform in Shor's Algorithm.

While the Schrodinger equation for a photon is complex, the amplitude function approximates to a classical sine wave. This compares to the equation of a compression wave (such as sound) through a solid, liquid, or gas. As such, some of the same computational principles and physical effects of QPM apply to compression waves. Transmission of a compression wave is probabilistic in nature due to the random thermodynamic properties of the medium. Additionally, a single particle can only move in one direction at one speed at a time. Overlaying multiple frequencies depends on utilizing many particles, and each particle cannot occupy the same point (classically). Despite these limitations, QPM as a technique could have many applications using compression waves and non-quantum computation. Examples include enhanced sonar, directed sound waves, underground imaging and ultrasound, and sonic weapons.

### Examples

### Medical

The application of cancer radiation has already been mentioned. QPM can greatly enhance existing uses of photon and proton radiation. Those receiving radiation treatments are warned that healthy tissue will absorb radiation in the process. This can cause general fatigue for weeks as one is recovering. It can also lead to permanent damage, as well as to new cancers down the road. By minimizing, and even nearly eliminating, radiation outside a target area— QPM can improve cancer treatment outcomes. If it were not feasible to place counterbalancing emitters at a 180-degree angle, it is also possible to fire beams from another angle and use vector contributions to compute a solution. This will expand the areas for scoring as it will expose new areas to radiation but may nevertheless be useful in some instances.

QPM could also be used for imaging such as X-Rays. Radiation can be focused to a certain depth or into a certain region more accurately, while protecting other areas. In the case of Magnetic Resonance Imaging, QPM could sculpt the magnetic field to a more specific area being examined. Options for non-invasive surgeries could be expanded using QPM for breakup of kidney stones and fragments in joints, smoothing of arthritic bone spurs, cardiac ablation, fat reduction, and cauterization.

A novel medical use involves injecting magnetic nanoparticles and causing them to pool in a target tissue using a QPM controlled magnetic field. Iron oxide nanoparticles have been successfully used for drug delivery and imaging purposes. By creating a magnetic field in a target tissue and nullifying it around the tissue, the nanoparticles would pass freely through the bloodstream and eventually become trapped in the target area. This pooling would occur based on the basic laws of probability. More advanced applications might monitor the flow of the nanoparticles to the target and then use a trigger such as an enzyme catalyst to dissolve or rupture the nanoparticle membranes—releasing a drug only where it is needed. QPM could be used in a broad way to manipulate the movement of magnetic (or statically charged) nanoparticles in any aerosol or aqueous environment.

### Communication and Electric Transmission

Many communication systems use line of sight technology or fiber optic technology where a single path is used. QPM can be used in these scenarios to reduce loss in transit and amplify signals at waypoints. Microwave towers, satellite links, and Internet cable generally use transmission systems that would allow QPM.

Much of the cost of electricity is tied to the resistance in electric lines. Transformer stations counter the resistance by increasing voltage at intervals. QPM could increase efficiency by amplifying power at specified points (perhaps power relay stations) and reducing power along the path of resistance. Recently wireless electric transmission has been tested, and QPM could increase efficiency in this area as well.

### Scientific and Other Applications

Microwave ovens are a marvel of technology. However, they tend to heat the exterior of a food item. Incorporating QPM targeting into a microwave would allow a more even heat distribution to occur by creating absorption layers for the radiation.

Controlling magnetic or electric fields is especially important in many scientific endeavors. For example, some quantum computers use levitating ions that are placed in a superposition state. QPM could be used to manipulate these ions more accurately or be able to reach ions behind a barrier. An electron tunneling microscope is a powerful tool for viewing the surface of an object at an atomic level. QPM could allow a similar instrument to view layers of a surface by emitting the imaging radiation to a prescribed depth.

Tornadoes cause vast amounts of property damage and unfortunately loss of life as well. Various mechanisms have been proposed to disrupt the organization of tornadoes (as well as hurricanes). Since the vortices are ultimately caused by a pressure/temperature differential—it has been suggested that heating the cooler air at the top of a tornado would stop the circulation. This could be accomplished by a missile with a high thermal output. QPM could provide another option. Emitters could target a point in the vortex, heating the air and water vapor. This would generally be inefficient due to the loss of energy in transit. QPM could radically change that, focusing the energy where it needs to go. Emitter arrays might be positioned on the perimeter of cities prone to tornadoes and tied into the power grid. Imaging data could be provided in real time into a computer for instant targeting solutions.

Focused energy is often used for the creation of semiconductor circuits. QPM would aid in this process by maximizing energy at the target spots. Another challenge in this process has historically been the use of photons with a small enough wavelength to meet increasing miniaturization requirements. A carefully designed wave combination could create an extremely narrow band with high amplitude with an abrupt cutoff surrounding it—even with higher wavelength constituent waves.

The order found within a crystal is useful in many processes, as well as the ability to modify its structure. QPM could be used to strike specific points within a crystal to create an impurity or hole by allowing radiation to bypass layers of atoms and amplify on a target.

Experimental fusion reactors such as the Tokamak use a magnetic field to contain high temperature (positively charged) plasma. This containment pressure pushes protons close enough together for the strong nuclear force to overpower the electric repulsion and cause a fusion reaction. QPM could assist in shaping the magnetic fields more optimally in this type of scenario, potentially reducing power consumption and making break even more feasible. QPM could also enable manipulation of single nuclei to push them close enough together, one by one, to cause nuclear fusion. It should be noted that while a wave combination can be created to cause a stationery amplitude signature, it can also be modified over time to move a charged particle (or magnetic material) if magnetic or electric waves are utilized.

Creating moving containment pockets for charged particles using QPM could also be utilized in supercooling. Extreme cold is necessary for experiments in superconductivity, quantum superpositions, and Bose-Einstein condensates. Moving a charged particle very slowly next to a target for cooling, and then releasing it could allow the manipulated particles to act as a heat sump for the target. Additionally, a magnetic or electric field could be shaped such that it has numerous valleys and peaks which charged particles are trapped in and are cooled as they transfer energy to the containment field.

Optical computing holds promise in increasing bandwidth and reducing power consumption over standard semiconductors. Photonic logic gates have been successfully constructed using non-linear optical materials combined with resonators. Using QPM, similar logic gates can be constructed that perform more complex logical operations—transcending single Boolean operations. For example, a zero-amplitude wave combination (along a linear QPM path) might exist at a certain point only if a specific logical combination of ten inputs is received. The inputs would correspond to ten waves being on or off. A combination not meeting the logical criteria would create non-zero amplitude. Different points on the path might correspond to varying other criteria and might be defined as an output of zero or one based on the amplitude being within a range above or below a threshold. Interaction of the waves at these “sampling” points with standard optical components would permit stacking of logical operations. For certain functions, a single QPM logic component might replace numerous stacked gates. In designing a QPM setup for a particular input/output need—the scoring system and appropriate degrees of freedom would be plugged in for optimization.

In the above example the scoring might be all or nothing for achieving zero amplitude at a fixed point, with disregard to amplitude elsewhere. Suppose that the logical criterion is a combination of seven inputs on or off, and three inputs of which only one is on (there would be three input combinations meeting the criterion). There would be degrees of freedom in the frequency of the light of each beam and in the intensity and the linear offset from the target. The optimization calculation would need to search all wave combinations, intensities, and linear offsets; and then score each combination against all 2\hat{ }10 permutations of inputs. For a wave combination to be considered acceptable it would have to score perfectly in every single input permutation—otherwise computational integrity would be compromised. It should be noted that this same principle could be applied to non-optical logic gates, such as those employing electric current or magnetic or electric fields.

### Military

An increased focus has been placed on the development of energy weapons by the US Military. Energy weapons offer speed (even light speed), but also have a few challenges. They are line of sight and must have a clear path. There may be thick armor on a target such as a tank or ballistic missile, or soil and rock surrounding a bunker. Fantastic energy levels may be required to rapidly penetrate hulls allowing an energy beam to reach a critical kill area within a target. Additionally, depending on the energy type, absorption and scattering will diminish a beam's strength in transit, unlike a missile which maintains constant strength within its range.

QPM can help solve all these issues. In some cases, a beam could be designed to pass through a friendly target, or a barrier like a wall, by minimizing the quantum absorption probability at that point—in effect teleporting the energy through the obstacle. Likewise, a beam could pass through the hull of a target and maximize absorption probability at the optimal location. Scattering and absorption in air can be factored into the calculations, further increasing the efficient use of power.

Weapons based on this technology could be developed by combining imaging technology such as infrared and radar and combining it with a database of known specs for various types of targets and barriers. A computing system tied to an array of wave emitters could respond instantly on the battlefield, whether on land, sea, air, or space. Weaponry could be used for targeting missiles, aircraft, and armored vehicles. Non-lethal crowd control weaponry could also use the technology. A QPM based system could strike specific terrorists inside a building without harming the structure or others inside. An aircraft carrier with a nuclear reactor would have a tremendous advantage in powering weapons of this kind. Weaponry might use the EM spectrum (such as microwave, visible light, or x-rays), or charged particles such as electrons or protons. A static electricity weapon could be built to incapacitate the electronic circuitry of an enemy vehicle or station by firing charged particles focused with QPM. Along these lines, it may be possible to construct an EMP type device that would bypass the normal constraints of a Faraday cage, by simply reducing the field strength to near zero at the cage.

Communications devices could be developed that allow a signal to effectively pass through an enemy position undetected, and gain amplitude at a desired target. QPM could also assist in sending signals through underground or heavily shielded locations.

Electronic circuitry relies on a steady current flow. A device could be created that taps into an incoming electric line and converts the energy using QPM to amplify on a target (such as a fuse box) to blow it out and render a site dark.

1. A system for delivering energy to a target, comprising:
a plurality of emitters, each emitter outputting a beam of quantum waves with an amplitude and a frequency;
wherein the frequencies of at least some of the beams are different, such that the quantum waves intersect and interfere at different points with a composite wave amplitude; and
a processor for optimizing the composite wave amplitude at a designated target.

2. The system of claim 1, including one or more beam combiners to form at least one combined linear wave path directed to a designated target.

3. The system of claim 1, wherein the quantum waves are polarized.

4. The system of claim 1, wherein amplitude cancellation minimizes the presence and absorption of the energy prior to, and after, the designated target.

5. The system of claim 1, wherein:
the waves have energy intensities; and
the energy densities are the same or different at the different frequencies.

6. The system of claim 1, including emitters with beams that are staggered or synchronized.

7. The system of claim 1, wherein the beam is used to heat, reduce or eliminate a biological or military target.

8. The system of claim 1, further including a computer processor, and wherein the processor is operative to calculate a Targeting Solution using the following steps:
a) defining a Target Space Array based on physical coordinates of a region of space affected by the emitted energy, including a time frame associated with when the energy will be within the region, and wherein the Target Space Array is quantized to represent discrete points in time and space or defined as a set of continuous functions;
b) adding information to the Target Space Array describing absorption properties of each region based on the density of differing molecules relative to different energies and frequencies;
c) monitoring thermal properties of each region, and adjusting temperature if required as a function of energy absorption;
d) defining a scoring system that rewards or penalizes energy absorption in each region as a function of frequency and heat;
e) defining a formula for combining the scores of each region to determine a Suitability Score;
f) defining an Emitter Configuration Array including, for each emitter:
energy type, frequency and intensity,
potential location and vector orientation,
potential polarization, and
the ability to start or stop emission during the time frame defined in the target space array.
g) generating wave functions associated with every possible permutation in the Emitter Configuration Array;
h) combining the wave functions with the Target Space Array to assign a Suitability Score to a plurality of Targeting Solutions, wherein the Suitability Score is based on quantum interference of intersecting waves or classical approximations, taking into account reduction of wave intensity due to prior absorption or scattering along a path; and
i) defining an optimal Targeting Solution as a permutation of options in the Emitter Configuration Array that produces the highest Suitability Score for a specific Target Space Array.

9. A method of delivering energy to one or more targets, comprising the steps of:
generating a beam of energy comprising a plurality of interfering quantum waves;
wherein the quantum waves have amplitudes and frequencies;
wherein at least some of the frequencies are different, such that the waves form one or more composite amplitudes; and
optimizing the composite amplitude at one or more designated targets.

10. The method of claim 9, wherein the waves are polarized.

11. The method of claim 9, wherein the beam of energy is delivered along a single linear path.

12. The method of claim 9, wherein amplitude cancellation minimizes the presence and absorption of energy prior to, and after, a designated target.

13. The method of claim 9, wherein the waves have energy intensities that are the same or different at different frequencies.

14. The method of claim 9, including the step of staggering emission points or synchronizing of the waves to enhance the optimization.

15. The method of claim 9, including the step of using the beam to heat, reduce or eliminate a biological or military target.

16. The method of claim 9, including the step of providing a quantum computer or other processor to calculate a Targeting Solution using the following steps:
a) defining a Target Space Array based on physical coordinates of a region of space affected by the emitted energy, including a time frame associated with when the energy will be within the region, and wherein the Target Space Array is quantized to represent discrete points in time and space or defined as a set of continuous functions;
b) adding information to the Target Space Array describing absorption properties of each region based on the density of differing molecules relative to different energies and frequencies;
c) monitoring thermal properties of each region, and adjusting temperature if required as a function of energy absorption;
d) defining a scoring system that rewards or penalizes energy absorption in each region as a function of frequency and heat;
e) defining a formula for combining the scores of each region to determine a Suitability Score;
f) defining an Emitter Configuration Array including, for each emitter:
energy type, frequency and intensity,
potential location and vector orientation,
potential polarization, and
the ability to start or stop emission during the time frame defined in the target space array.
g) generating wave functions associated with every possible permutation in the Emitter Configuration Array;
h) combining the wave functions with the Target Space Array to assign a Suitability Score to a plurality of Targeting Solutions, wherein the Suitability Score is based on quantum interference of intersecting waves or classical approximations, taking into account reduction of wave intensity due to prior absorption or scattering along a path; and
i) defining an optimal Targeting Solution as a permutation of options in the Emitter Configuration Array that produces the highest Suitability Score for a specific Target Space Array.

17. A method of delivering energy to one or more targets, comprising the steps of:
generating a beam of energy comprising a plurality of interfering electromagnetic waves;
wherein the electromagnetic waves have amplitudes and frequencies;
wherein at least some of the frequencies are different, such that electric or magnetic field strength or orientation are different at different points along the beam; and
optimizing the electric or magnetic field strength or orientation at one or more designated targets.

18. The method of claim 17, wherein the waves one or more of the following properties:
they are polarized;
they travel along a single linear path; and
they have energy intensities that are the same or different at the different frequencies or from different emitters.

19. The method of claim 17, including the step of staggering emission points or synchronizing of the waves to enhance the optimization; and
wherein the optimization at a designated target causes one or more ions or magnetic objects at a target to be moved, trapped, levitated, vibrated, heated, or cooled.

20. The method of claim 17, including the step of providing a quantum computer or other processor to calculate a Targeting Solution using the following steps:
a) defining a Target Space Array based on physical coordinates of a region of space affected by the emitted energy, including a time frame associated with when the energy will be within the region, and wherein the Target Space Array is quantized to represent discrete points in time and space or defined as a set of continuous functions;
b) adding information to the Target Space Array describing absorption properties of each region based on the density of differing molecules relative to different energies and frequencies;
c) monitoring thermal properties of each region, and adjusting temperature if required as a function of energy absorption;
d) defining a scoring system that rewards or penalizes energy absorption in each region as a function of frequency and heat;
e) defining a formula for combining the scores of each region to determine a Suitability Score;
f) defining an Emitter Configuration Array including, for each emitter:
energy type, frequency and intensity,
potential location and vector orientation,
potential polarization, and
the ability to start or stop emission during the time frame defined in the Target Space Array.
g) generating wave functions associated with every possible permutation in the Emitter Configuration Array;
h) combining the wave functions with the Target Space Array to assign a Suitability Score to a plurality of Targeting Solutions, wherein the Suitability Score is based on quantum interference of intersecting waves or classical approximations, taking into account reduction of wave intensity due to prior absorption or scattering along a path; and
i) defining an optimal Targeting Solution as a permutation of options in the Emitter Configuration Array that produces the highest Suitability Score for a specific Target Space Array.
